(19) United States
(12) Patent Application Publication
(10) Pub. No.: US 2008/0164870 A1
(43) Pub. Date: Jul. 10, 2008

(54) Arrangement for Measuring the Position of a Magnet Relative to a Magnetic Core

(76) Inventors: Johannes Beichler, Eppertshausen (DE); Dirk Heumann, Nidderau (DE); Norbert Preusse, Alzenau (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/968,985

(22) Filed: Jan. 3, 2008

(30) Foreign Application Priority Data
Jan. 10, 2007 (DE) 10 2007 001 606.0

(51) Int. Cl. G01B 7/14

(52) U.S. Cl. 324/207.15

(57) ABSTRACT

An arrangement for measuring the position of a magnet relative to a ferromagnetic magnetic core, has a magnetic core, a conductor, which is guided in such a way through the toroidal core that the conductor and the toroidal core form an inductive arrangement, and an evaluation circuit for evaluating the saturation state of the toroidal core of the inductive arrangement as a measure of the distance of the magnet relative to the magnetic core.

### CROSS-REFERENCE TO RELATED APPLICATIONS

This application claims priority to German application number 10 2007 001 606.0 filed Jan. 10, 2007, the contents of which is hereby incorporated by reference in its entirety.

### TECHNICAL FIELD

The present invention relates to a sensor arrangement comprising one or more magnetic cores, for example, toroidal cores or microtoroidal cores, for measuring the position of a magnet relative to these toroidal cores.

### BACKGROUND

In many applications, it is necessary to detect the position of a transmitter element for measuring the position of the same or also for activating switching operations. For this purpose, only contactless measuring methods are used in most cases for reasons of robustness and simplicity. Thus there are basically two possibilities—namely, an optical or a magnetic detection of the position of the transmitter element. However, in harsh environments, optical methods suffer from the disadvantage of being prone to contamination and interference. Consequently, the robustness required is generally not achieved when using optical methods. Magnetic methods are thus usually given preference. A magnet, for example, a permanent magnet, the position of which is supposed to be determined, frequently serves as the transmitter element.

Several possibilities are known for detecting the position of a magnet. An example of one possibility for this purpose is the direct measurement of the magnetic field with the help of Hall elements or magneto-resistive sensors. In a corresponding arrangement of magnet and sensor, the output signal of these sensors is proportional to the magnetic field of the transmitter magnet observed, and the position of the latter can be determined therefrom. However, such types of magnetic field sensors have undesirable offset voltages and temperature drifts, which make it difficult to perform sufficiently accurate measurements. Another disadvantage of Hall elements is that very high magnetic fields are required for activating them.

Another method for detecting the position of a transmitter magnet uses one or more reed relays. One reed relay is required for each position to be detected. This reed relay is connected when the transmitter magnet comes sufficiently close to the reed relay. However, reed relays are always subject to a certain degree of wear when used as magneto-mechanical switches and are designed only for a certain number of switching cycles. In addition, by nature they have relatively long response times of 5 ms or more. Shorter response times are only possible when using purely electronic solutions, for example, Hall switches, which however suffer from the aforementioned problems of offset voltages and temperature drifts. Furthermore, measures for debouncing are frequently required when using mechanical switches.

### SUMMARY

A sensor arrangement for the magnetic, contactless measurement of position, can be provided which enables an exact and reproducible switching behavior with appropriately short switching times.

According to an embodiment, an arrangement for measuring the position of a magnet relative to a magnetic core, said arrangement may comprise a magnet, a ferromagnetic magnetic core, a conductor, which is guided through the toroidal core in such a way that the conductor and the toroidal core form an inductive arrangement, and an evaluation circuit for evaluating the saturation state of the toroidal core of the inductive arrangement as a measure of the distance of the magnet relative to the magnetic core.

According to another embodiment, the magnetic core can be designed as a toroidal core. According to another embodiment, the toroidal core can be formed of amorphous or nanocrystalline films having maximum thicknesses of 30 μm and relative permeabilities of at least 20,000. According to another embodiment, the toroidal core can be designed as a miniature toroidal strip core having a maximum winding height of 0.3 mm. According to another embodiment, the toroidal core may have a maximum core height of 2 mm. According to another embodiment, the magnetic core can be designed as a punching disc having a maximum thickness of 30 μm. According to another embodiment, the magnetic core can be designed as a stack of punching discs having a maximum height of 1.0 mm. According to another embodiment, the magnetic core may have a maximum diameter of 2 mm. According to another embodiment, several inductive arrangements can be disposed at a distance from each other and connected to the evaluation circuit. According to another embodiment, the evaluation circuit can be designed to evaluate all inductive arrangements in parallel. According to another embodiment, the evaluation circuit can be designed to evaluate the inductive arrangements sequentially. According to another embodiment, each conductor can be guided only once through the corresponding toroidal core. According to another embodiment, the evaluation circuit may comprise an oscillator and all inductive arrangements may be activated by this oscillator. According to another embodiment, the inductive arrangements can be disposed at regular distances from each other and the magnet can be adapted in such a way to the distance between the inductive arrangements, that when the magnet is located exactly over an inductive arrangement, only the toroidal core of this inductive arrangement is saturated. According to another embodiment, the magnet can be adapted in such a way to the distance between the inductive arrangements that when the magnet is located exactly between two inductive arrangements, the magnetic cores of both the inductive arrangements are saturated. According to another embodiment, the arrangement additionally may comprise a multi-layer printed circuit board on which the inductive arrangements are disposed. According to another embodiment, the magnetic cores can be implemented in a layer of a multi-layer printed circuit board. According to another embodiment, the evaluation circuit can be likewise disposed on the multi-layer printed circuit board. According to another embodiment, a soft magnetic sheet can be disposed on that side of the inductive arrangements that is turned away from the magnet. According to another embodiment, the soft magnetic sheet can be made of mumetal. According to another embodiment, the soft magnetic sheet can be built of amorphous or nanocrystalline films. According to another embodiment, the soft magnetic sheet can be implemented in a layer of a multi-layer printed circuit board.

### BRIEF DESCRIPTION OF THE DRAWINGS

The invention is explained in more detail below with reference to the figures, in which:

FIG. 1 shows a sensor arrangement according to an embodiment comprising several toroidal cores disposed at regular distances along a line, and a conductor, which is guided through each toroidal core and is connected to an evaluation circuit.

FIG. 2 shows a possible evaluation circuit, which makes it possible to query the saturation state of all toroidal cores in parallel.

FIG. 3 shows the sensor arrangement according to the embodiment shown in FIG. 1, however, with a soft magnetic plate additionally disposed on that side of the toroidal cores that is turned away from the transmitter magnet.

FIGS. 4a & 4b show the sensor arrangement according to the embodiment shown in FIG. 1, however, in the cross-section thereof. The possibility of increasing the resolution power of the sensor arrangement is shown, when the magnet is adapted in such a way to the distance between the toroidal cores that two adjacent toroidal cores are saturated when the magnet is located exactly between the two cores.

Unless indicated otherwise, like reference numerals refer to like components having equivalent meaning in the following figures.

### DETAILED DESCRIPTION

According to various embodiments, the advantages of the aforementioned magneto-mechanical method, namely, exactly reproducible switching behavior without signs of offset voltage or temperature drifts, is combined with the advantages of the aforementioned electronic method, namely, an appropriately rapid switching behavior without signs of mechanical wear.

According to an embodiment, a ferromagnetic magnetic core, particularly a microtoroidal core, is provided as the sensor element, which is magnetically saturated by the magnetic field of the transmitter magnet, as soon as the transmitter magnet is located sufficiently close to the microtoroidal core. These microtoroidal cores typically have a very high relative permeability (greater than 20,000) in the unsaturated state. In contrast, the relative permeability can reduce to value 1 in the saturated state.

The saturation state of a magnetic core can be detected easily with the help of an electric conductor disposed close to the core. Such an arrangement is referred to as “inductive arrangement” in the following. In an embodiment comprising a microtoroidal core, the conductor can be guided at least once through the core.

In the case of an unsaturated core, the inductive arrangement has a very high inductance. However, if the transmitter magnet magnetically saturates the magnetic core, the value of inductance reduces considerably. This change in inductance is determined according to an embodiment by an evaluation circuit, there existing a monotonic functional correlation between the position of the transmitter magnet relative to the magnetic core observed and the determined inductance, i.e., when the distance between the transmitter magnet and the magnetic core reduces, the inductance of the inductive arrangement composed of the magnetic core and the conductor also reduces.

If the inductance value of the inductive arrangement is not measured directly in the evaluation circuit, but instead only compared with a reference value and the result of this comparison operation is provided at an output as a binary logic signal, then in the proximity of the transmitter magnet, such an inductive arrangement consisting of the magnetic core and conductor acts similarly to a reed relay, however without the disadvantages commonly associated with mechanical switches (for example, bouncing and long switching times). This arrangement also does not show any signs of temperature drifts and offset voltages occurring in other magnetic sensors.

According to another embodiment, not just a single magnetic core with an electric conductor is used. Instead, a plurality of inductive arrangements, each having a core, is disposed at regular or irregular distances from each other. If a transmitter magnet now moves over this arrangement of magnetic cores, the position of the transmitter magnet can be easily determined—it is located at the position of that magnetic core which is just “connected,” i.e., magnetically saturated.

When using toroidal cores, in the simplest case, one conductor is guided through each toroidal core only once.

When using microtoroidal cores, this structure can be disposed very easily on a printed circuit board or in several layers of a multi-layer printed circuit board. In order to improve the “switching behavior” of the toroidal cores, a soft magnetic plate, for example, made of mumetal (Ni77/Fe14/Cu5/MO4), can be disposed on that side of the toroidal cores that is turned away from the transmitter magnet. The magnetic field lines of the transmitter magnet are thus “attracted” to the plate, the magnetic flux is guided in the plate and there results lesser leakage flux, due to which the switching behavior in turn becomes sharper, i.e., the transition from high inductance to low inductance becomes steeper. This soft magnetic plate can also be implemented as a film in a multi-layer printed circuit board.

A further increase in the spatial resolution of such an arrangement can be achieved by adapting the transmitter magnet in such a way to the distance between two magnetic cores that two adjacent cores are saturated when the transmitter magnet is located exactly between them.

The microtoroidal cores used are, for example, toroidal cores formed of amorphous or nanocrystalline films having maximum thicknesses of 30 μm and relative permeabilities of at least 20,000, either in the form of a wound toroidal strip core or in the form of a disc punched from such a film. It is also possible to build a toroidal core from a stack of several such punching discs having a maximum height of 1.0 mm. Toroidal cores built in this way can be easily integrated into multi-layer printed circuit boards and are described in the German patent specification DE 199 07 542 C2 by way of example. As mentioned above, another possibility is the use of the aforementioned film for producing miniature toroidal strip cores having a maximum winding height of 0.3 mm, a maximum core height of 2 mm and a maximum diameter of 2 mm. The production of such types of miniature toroidal strip cores is described in the German patent specification DE 198 51 871 T2 by way of example.

If the sensor arrangement is built with the help of such types of miniature cores, then the toroidal cores and the evaluation circuit can be accommodated on the same printed circuit board and thus a compact sensor module for position determination can be implemented.

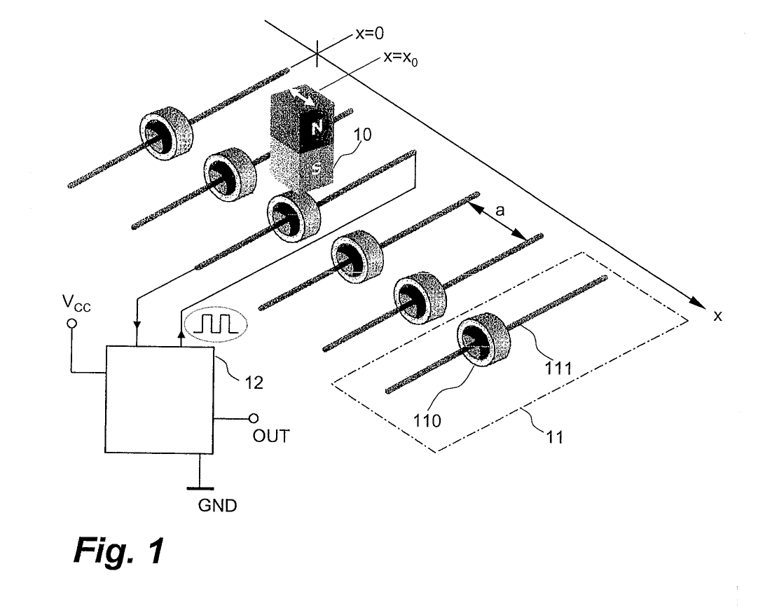

FIG. 1 shows a possible sensor arrangement according to an embodiment. This sensor arrangement comprises several toroidal cores 110, which are disposed at regular distances “a” and through each of which a conductor 111 is guided. By guiding one conductor 111 through each toroidal core 110, inductive arrangements 11 are formed, which are all connected to the evaluation circuit 12. (For the sake of clarity, the figure shows only the connection of one inductive arrangement 11 to the evaluation circuit 12.) All toroidal cores 110 are disposed along a straight line, which simultaneously also represents the coordinate axis x, a first toroidal core 110 being disposed in the origin of the coordinate system x=0. A permanent magnet in the form of a transmitter magnet 10 is disposed in such a way over the toroidal core 110 that it is displaceable along the coordinate axis x across the toroidal cores. The direction of magnetization of the transmitter magnet can be as shown in FIG. 1. The two possibilities orthogonal thereto are likewise feasible and result in a response behavior that is modified in relation to the width of the partition region and distance. Each current position of the transmitter magnet 10 is described by the coordinate x=x0. The coordinates of all inductive arrangements 11 or all toroidal cores 110 are known a priori so that it is possible to conclude the following after determining the saturation state of all toroidal cores 110: The transmitter magnet 10 is located at the same coordinate position x0 as that toroidal core 110, which has just been magnetically saturated. For this simple case, the transmitter magnet 10 should be dimensioned, i.e., adapted to the distance between the toroidal cores 110, in such a way that depending on the position of the transmitter magnet 10, only one toroidal core 110 at a time (namely, the one located closest to the transmitter magnet 10) is saturated magnetically.

After having established which of the toroidal cores has just been saturated, it is possible to clearly detect the position of the transmitter magnet 10. The resolution of this sensor arrangement is then determined by the distance “a” between two adjacent inductive arrangements 11. Nevertheless, the manner in which the resolution power of the sensor arrangement can be increased is described further below.

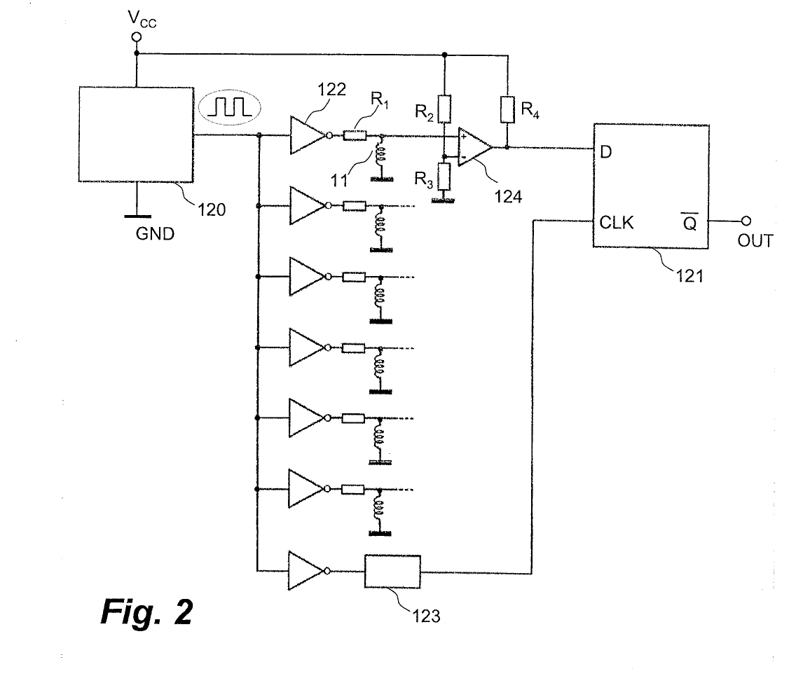

All inductive arrangements 11 are connected to the evaluation circuit 12. Furthermore, the evaluation circuit 12 is connected to a first supply potential V_{CC} and a second supply potential GND. At an output OUT, it is indicated which of the toroidal cores 110 has just been saturated magnetically. Such an evaluation circuit 12 is shown in FIG. 2 by way of example.

The evaluation circuit comprises an oscillator 120, which has an oscillator frequency f₀ and is connected via inverters 122 and resistors R₁ to the inductive arrangements 11 and excites the latter with a rectangular wave. Each of the inductive arrangements 11 and the resistors R₁ forms high-pass filters with the limiting frequency f_{G}=R₁/(2πL), where L refers to the current inductance of the inductive arrangement 11 observed. This inductance L has a low inductance L=L_{G} in the case of a saturated toroidal core, and a high inductance L=L_{U} in the case of an unsaturated toroidal core 110. Thus not only the inductance L of the inductive arrangement 11, but also the limiting frequency f_{G} of the high-pass filter belonging to the respective inductive arrangement 11 change with the saturation state of the toroidal cores.

If the resistors R₁ are now adapted in such a way to the oscillator frequency f₀, that the limiting frequency f_{G} of the associated high-pass filter lies above the oscillator frequency f₀ in the case of a saturated toroidal core 110, and below the oscillator frequency f₀ in the case of an unsaturated toroidal core 110, then it is easily possible to decide using a comparator 124 whether the respective toroidal core 110 is saturated or not and thus also whether the transmitter magnet is located at the coordinate position of the respective toroidal core 110 or not. For this purpose, a first input of the comparator 124 is connected to the high-pass filter, i.e., to the resistor R₁ and the inductive arrangement 11. The reference value with which the comparator compares the output signal of the high-pass filter is adjusted by using the resistors R₂ and R₃. A second input of the comparator 124 is thus connected via the resistor R₃ to the second supply potential GND and via the resistor R₂ to the first supply potential V_{CC}; the resistors R₂ and R₃ thus form a voltage divider. The result of the comparison is shown as a logic level at the output of the comparator 124, a high level indicating a saturated toroidal core 110.

In order to also be able to process this output signal of the comparator 124 further, it is connected to the D-input of an edge triggered D-latch, the CLK-input of which is likewise connected to the oscillator 120 via a delay circuit 123 and an inverter. The delay time of the delay circuit 123 is exactly adjusted in such a way that the D-latch “scans” the output signal of the comparator 124 precisely at the point in time at which the comparator 124 has assumed a stable state. The comparison result of the comparator 124 is then provided at the output OUT₀ of the D-latch 121 for further processing. Naturally each inductive arrangement 11 is provided with resistors R₂ to R₄, inverter 122, comparator 124, and D-latch 121, even though these components are drawn in the FIG. 2 only once for the first inductive arrangement for the sake of clarity. In a sensor arrangement comprising six toroidal cores 110, as shown in FIG. 1, there are thus six inverters 122, six comparators 124 with the associated resistors, and six D-latches 121 with six outputs OUT₀ to OUT₆ present as well. At the outputs OUT₀ to OUT₆, it is indicated which of the toroidal cores has just been saturated. The time-based resolution, i.e., the response time to a change in the saturation state of the toroidal cores is alone determined by the oscillator frequency f₀.

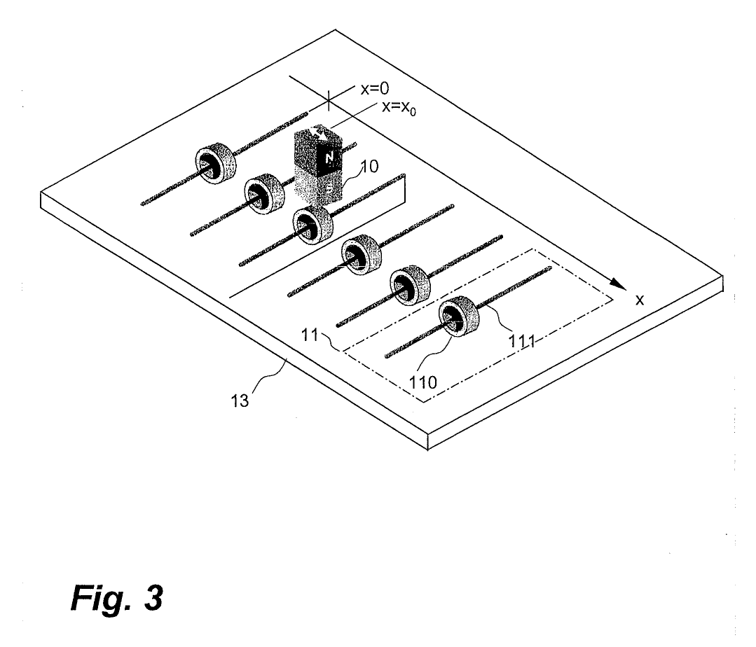

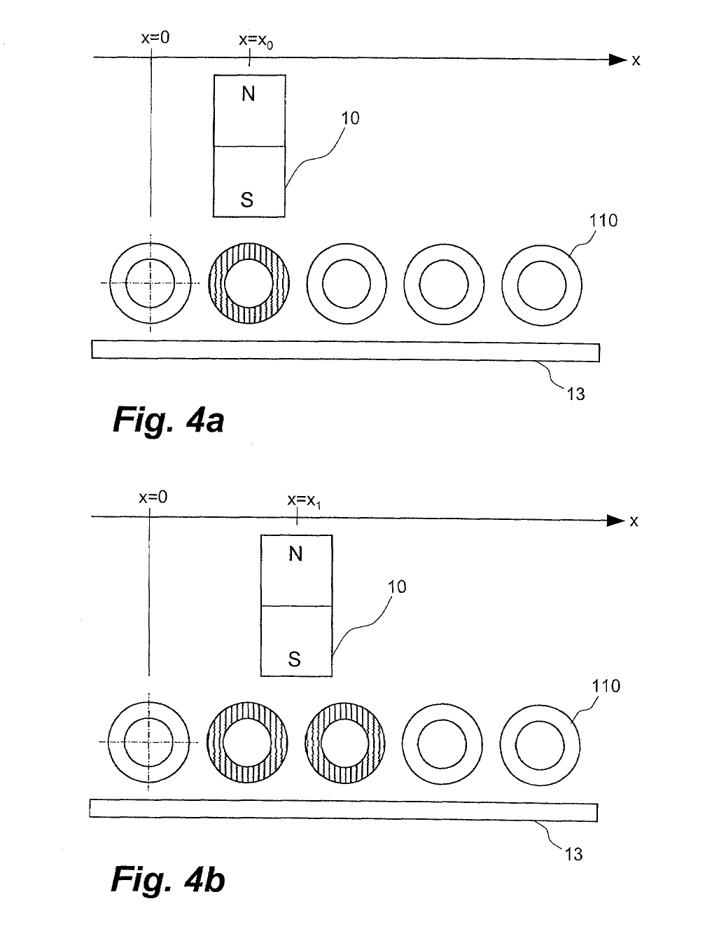

In the embodiment described above, the achievable resolution of the sensor arrangement is determined by the distance “a” between two inductive arrangements 11. FIGS. 3 and 4 show a possibility of doubling the resolution power of the sensor arrangement. FIG. 3 shows a sensor arrangement, as in FIG. 1, however with a soft magnetic plate 13 disposed additionally on that side of the inductive arrangements 11 that is turned away from the transmitter magnet 10. An example of a suitable material for the plate 13 is mumetal. The magnetic field lines of the transmitter magnet 10 are “attracted” to the soft magnetic plate 13, thereby enabling better guidance of the magnetic field, reduction of the leakage flux and thus better switching behavior and increase in accuracy.

The resolution power of the sensor arrangement can now be improved by adapting the transmitter magnet 10, as shown in FIGS. 4a) and 4b) in such a way to the distance between two toroidal cores 110 that only one toroidal core 110 is saturated when the transmitter magnet 10 is located exactly over the related toroidal core 110 (cf. FIG. 4a) and that two adjacent toroidal cores 110 are saturated when the transmitter magnet 10 is located exactly between the two toroidal cores 110 observed (cf. FIG. 4b). Such dimensions can thus also help detect intermediate states, and the resolution power of the sensor arrangement then corresponds to half the distance between two adjacent toroidal cores 110.

As has already been explained in detail above, the toroidal cores can be integrated into multi-layer printed circuit boards if amorphous or polycrystalline ferromagnetic films are used for the toroidal cores. The soft magnetic plate 13 can likewise be formed by a film of such type within a multi-layer printed circuit board.

What is claimed is:

1. An arrangement for measuring the position of a magnet relative to a magnetic core, said arrangement comprising:
a magnet,
a ferromagnetic magnetic core,
a conductor, which is guided through the toroidal core in such a way that the conductor and the toroidal core form an inductive arrangement, and
an evaluation circuit for evaluating the saturation state of the toroidal core of the inductive arrangement as a measure of the distance of the magnet relative to the magnetic core.

2. The arrangement according to claim 1, wherein the magnetic core is designed as a toroidal core.

3. The arrangement according to claim 2, wherein the toroidal core is formed of amorphous or nanocrystalline films having maximum thicknesses of 30 μm and relative permeabilities of at least 20,000.

4. The arrangement according to claim 2, wherein the toroidal core is designed as a miniature toroidal strip core having a maximum winding height of 0.3 mm.

5. The arrangement according to claim 2, wherein the toroidal core has a maximum core height of 2 mm.

6. The arrangement according to claim 1, wherein the magnetic core is designed as a punching disc having a maximum thickness of 30 μm.

7. The arrangement according to claim 1, wherein the magnetic core is designed as a stack of punching discs having a maximum height of 1.0 mm.

8. The arrangement according to claim 1, wherein the magnetic core has a maximum diameter of 2 mm.

9. The arrangement according to claim 1, wherein several inductive arrangements are disposed at a distance from each other and connected to the evaluation circuit.

10. The arrangement according to claim 9, wherein the evaluation circuit is designed to evaluate all inductive arrangements in parallel.

11. The arrangement according to claim 9, wherein the evaluation circuit is designed to evaluate the inductive arrangements sequentially.

12. The arrangement according to claim 9, wherein each conductor is guided only once through the corresponding toroidal core.

13. The arrangement according to claim 9, wherein the evaluation circuit comprises an oscillator and all inductive arrangements are activated by this oscillator.

14. The arrangement according to claim 9, wherein the inductive arrangements are disposed at regular distances from each other and the magnet is adapted in such a way to the distance between the inductive arrangements, that when the magnet is located exactly over an inductive arrangement, only the toroidal core of this inductive arrangement is saturated.

15. The arrangement according to claim 14, wherein the magnet is adapted in such a way to the distance between the inductive arrangements that when the magnet is located exactly between two inductive arrangements, the magnetic cores of both the inductive arrangements are saturated.

16. The arrangement according to claim 1, wherein the arrangement additionally comprises a multi-layer printed circuit board on which the inductive arrangements are disposed.

17. The arrangement according to claim 16, wherein the magnetic cores are implemented in a layer of a multi-layer printed circuit board.

18. The arrangement according to claim 16, wherein the evaluation circuit is likewise disposed on the multi-layer printed circuit board.

19. The arrangement according to claim 1, wherein a soft magnetic sheet is disposed on that side of the inductive arrangements that is turned away from the magnet.

20. The arrangement according to claim 19, wherein the soft magnetic sheet is made of mumetal.

21. The arrangement according to claim 19, wherein the soft magnetic sheet is built of amorphous or nanocrystalline films.

22. The arrangement according to claim 19, wherein the soft magnetic sheet is implemented in a layer of a multi-layer printed circuit board.
